(19) United States
(12) Patent Application Publication
(10) Pub. No.: US 2002/0171226 A1
(43) Pub. Date: Nov. 21, 2002

(54) Draw bar/hitch bar having angled end

(76) Inventors: Richard W. McCoy, Granger, IN (US); Jason R. Moldthan, Osceola, IN (US)

Correspondence Address: KING & SCHICKLI, PLLC, 247 NORTH BROADWAY, LEXINGTON, KY, 40507, US

(21) Appl. No.: 10/151,225

(22) Filed: May 20, 2002

Related U.S. Application Data
(60) Provisional application No. 60/292,370, filed on May 21, 2001.

(51) Int. Cl. B60D 1/00

(52) U.S. Cl. 280/491.5

(57) ABSTRACT

A draw bar/hitch bar includes a top wall, bottom wall, first side wall, second side wall, first end and second end. The first end defines an included angle with one of the walls of between substantially 65-85°. That one wall projects beyond the opposite wall at the first end by about 1.27-2.54 cm. The draw bar/hitch bar may be connected into the receiver box of a trailer hitch receiver assembly by inserting a first projecting edge of the draw bar/hitch bar into the receiver box, pivoting the draw bar/hitch bar so as to insert a second, opposite edge into the receiver box and seating the draw bar/hitch bar fully into the receiver box.

This application claims the benefit of U.S. Provisional Patent Application Serial No. 60/292,370 filed May 21, 2001.

### TECHNICAL FIELD

The present invention relates generally to the trailer towing field and, more particularly, to a new and improved drawbar or hitch bar including a novel, angled end that is received in the receiver box of a trailer hitch receiver assembly.

### BACKGROUND OF THE INVENTION

It has long been known in the art to provide a trailer hitch receiver assembly for towing a trailer behind a vehicle. Such a trailer hitch receiver assembly includes a hitch bar receiver assembly generally incorporating a receiver box carried by a cross member that is connected by two mounting brackets to the frame of a vehicle. Examples of such a trailer hitch receiver assembly include, for example, the Shadow Mount, class I, Omni Multi-Fit class II, Insta-Hitch class II, Titan Class V and 35, 36 and 37 series Class III/IV receivers presently manufactured and marketed by Reese Products, Inc. of Elkhart, Indiana.

The trailer hitch receiver assembly also includes a drawbar or hitch bar that is pinned or otherwise secured in the receiver box of the hitch bar receiver assembly mounted to the vehicle. Drawbar arrangements are typically quite simple and commonly comprise a solid or tubular section of ductile iron or steel that either includes (a) an aperture for directly receiving a trailer towing ball or (b) functions as a post and is connected to a mounting rack or support that receives such a trailer towing ball. A hitch bar typically comprises a post and a mounting rack or support which carries a ball mount head that receives a trailer hitch ball. Hitch bars are commonly associated with weight distributing hitches. The basic types of drawbars and hitch bars are well known in the art and are disclosed, for example, in U.S. Pat. Nos. 3,482,856 to Reese; 3,768,837 to Reese; 4,033,601 to Lindahl, et al.; 5,890,726 to McCoy et al.; 5,620,198 to Borchers; and 5,562,298 to Kass et al. all owned by Reese Products, Inc., the assignee of the present invention.

In the over 30 years since this basic type of trailer hitch receiver assembly was developed, numerous design modifications have been made with the goal of improving the overall product. For example, competitive pressures in the marketplace have led various manufacturers of trailer hitch receiver assemblies to make a serious effort to control manufacturing costs while at the same time increasing the overall useful life of the assemblies to benefit the end user. While significant improvements have been made, these competitive pressures are still present and still further improvements relating to cost controls and performance enhancements are desired. Toward this end the present invention relates to a new and improved drawbar or hitch bar incorporating a unique angled end that significantly simplifies and aids in the installation of the drawbar or hitch bar into the receiver box of the trailer hitch receiver assembly. This makes the draw bar/hitch bar connection in the receiver box more convenient and user friendly.

### SUMMARY OF THE INVENTION

The present invention provides a draw bar/hitch bar that is particularly adapted for simple and convenient insertion in the receiver box of a trailer hitch receiver assembly.

Additional advantages of the novel features of the invention will be set forth in part in the description that follows and in part will become apparent to those skilled in the art upon examination of the following or may be learned with the practice of the invention. The benefits and advantages of the invention may be realized and obtained by means of the instrumentalities and combinations particularly pointed out in the appended claims.

In accordance with the purposes of the present invention as described herein, a draw bar/hitch bar comprises a body including a top wall, a bottom wall, a first side wall, a second side wall, a first end and a second end. The first end defines an included angle with the top wall of less than 90° and typically between substantially 65-85° and more typically about 72°. The top wall also projects beyond the bottom wall at the first end between substantially 1.27-2.54 cm and more typically about 1.68 cm.

The first side wall may include a first mounting aperture while the second side wall may include a second mounting aperture. Typically the first and second mounting apertures are aligned so as to be adapted to receive a hitch pin of a type known in the art for securing the draw bar/hitch bar to the receiver box of a trailer hitch receiver assembly. Such a hitch pin is typically held in place by a head at one end and a pin clip at the other.

The invention may be more broadly defined as comprising a hitch bar or drawbar including first, second, third and fourth walls and first and second ends wherein the first end defines an included angle with the first wall of between substantially 65-85°. Alternatively, another broad definition of the invention is a hitch bar or drawbar comprising a body including first, second, third and fourth walls and first and second ends wherein the first wall projects beyond at least one of the second, third and fourth walls at the first end between substantially 1.27-2.54 cm and more typically 1.68 cm.

In accordance with still another aspect of the present invention, a method of inserting a draw bar/hitch bar into the receiver box of a trailer hitch receiver assembly is provided. That method includes the steps of inserting a first projecting edge of the draw bar/hitch bar into the receiver box, pivoting the draw bar/hitch bar so as to insert a second, opposite edge of the draw bar/hitch bar into the receiver box and seating the draw bar/hitch bar fully into the receiver box. The method may be further defined as including the pinning of the draw bar/hitch bar into the receiver box.

The complete details of the present invention will become apparent to those skilled in this art from the following description wherein there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain the principles of the invention. In the drawings:

FIG. 1 is a perspective view of the draw bar/hitch bar of the present invention;

FIG. 1a is a side elevation view of the draw bar/hitch bar shown in FIG. 1 illustrating the angled end of the draw bar/hitch bar which simplifies and makes more convenient the insertion of the draw bar/bitch bar into a trailer hitch receiver assembly;

FIGS. 2a-2d are a series of views illustrating the inter-connection of the draw bar/hitch bar of the present invention into a receiver box of a trailer hitch receiver assembly of a type well known in the art.

Reference will now be made in detail to the present preferred embodiment of the invention, an example of which is illustrated in the accompanying drawings.

### DETAILED DESCRIPTION OF THE INVENTION

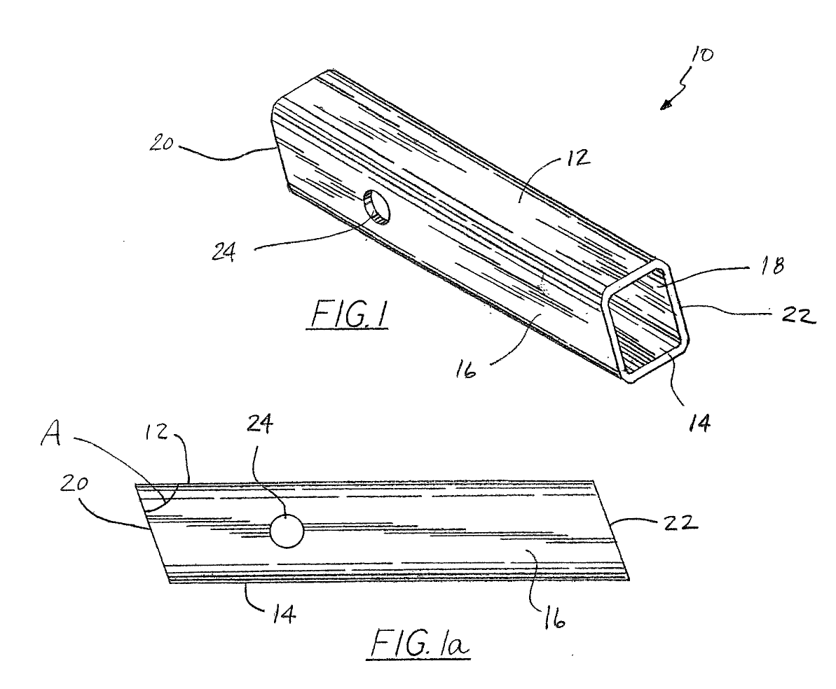

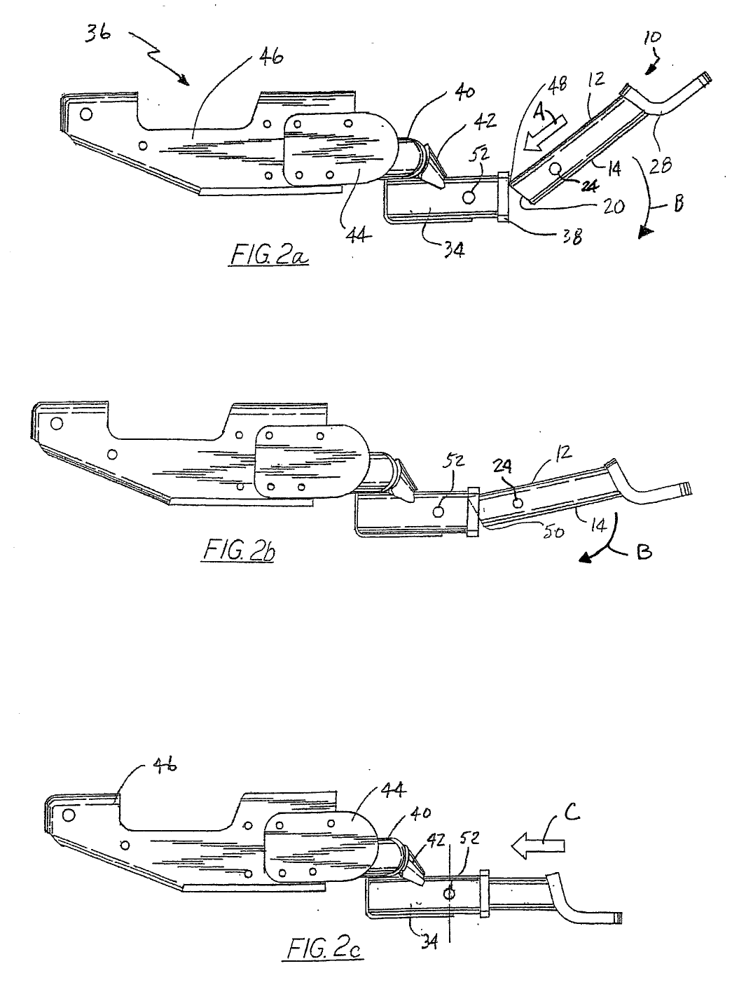

Reference is now made to drawing FIGS. 1 and 1a showing the improved draw bar/hitch bar 10 of the present invention. The draw bar/hitch bar 10 may be cast, rolled, forged or extruded from steel, ductile iron or other high strength material. It may be tubular as illustrated (i.e. including a lumen) or it may be of solid construction. It may also be formed in substantially any useful length. The draw bar/hitch bar is sized and shaped for receipt in a receiver box of a trailer hitch receiver assembly of a type well known in the art.

The draw bar/hitch bar 10 includes a first or upper wall 12, a second or lower wall 14, a first side wall 16, a second side wall 18, a first end 20 and a second end 22. Each of the side walls 16, 18 includes a mounting aperture 24 (only one is shown in FIGS. 1 and 1a). The mounting apertures 24 are aligned so as to be adapted for receipt of a hitch pin 26 of a type well known in the art to secure a draw bar/hitch bar in the receiver box of a trailer hitch receiver assembly.

As best shown in FIG. 1a, the first or top wall 12 projects beyond the second or bottom wall 14 at the first end 20 of the draw bar/hitch bar 10. More specifically, the top wall 12 projects beyond the bottom wall 14 at the second end 20 between approximately 1.27-2.54 cm. As a result, the second end 20 forms an included angle A with the top wall 12 of less than 90° and typically between substantially 65-85°. In one possible embodiment, the top wall 12 projects beyond the bottom wall 14 by about 1.68 cm and the included angle A is about 72°.

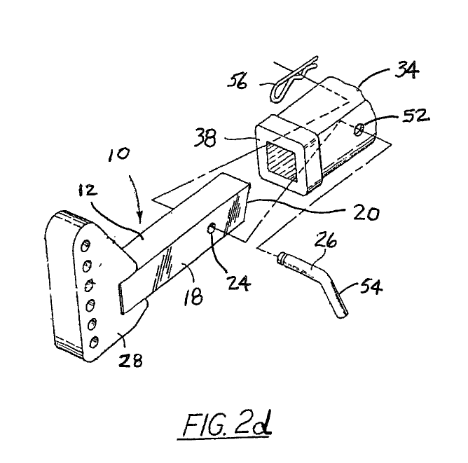

The second end 22 of the draw bar/hitch bar 10 is cut or shaped for receipt of a mounting head or support of any type known in the art such as illustrated by reference numeral 28 in FIGS. 2a-2d. In the illustrated embodiment the mounting head or support 28 includes an aperture for receiving the threaded stem of a trailer hitch ball 30. A cooperating locking nut 32 is tightened on the threaded stem of a hitch ball 30 in order to secure the hitch ball in position on the support 28.

The method of inserting the draw bar/hitch bar 10 of the present invention into the receiver box 34 of a trailer hitch receiver assembly 36 will now be described with reference to FIGS. 2a-2d. The trailer hitch receiver assembly 36 shown in these figures is fairly typical of present designs and incorporates the receiver box 34 with a reinforced lip 38 that is welded in an underslung position to a cross member 40. A gusset 42 is welded between the receiver box 34 and the cross member 40 in order to increase the integrity of the connection. A mounting flange 44 is provided at each end of the cross member 40 (only one is shown in the drawing figures). A mounting bracket 46 (only one is shown in the drawing figures) is secured to each mounting flange 44. As is known in the art, each mounting bracket 46 includes one or more skirts with apertures that receive cooperating fasteners for securing the trailer hitch receiver assembly 36 to the frame rails of a vehicle. Of course, in the alternative the connection could be made by welding or other means.

The draw bar/hitch bar 10 of the present invention is connected to the trailer hitch receiver assembly 36 by inserting a first projecting edge 48, formed by the included angle A between the upper wall 12 and the first end 20 into the receiver box 34 (note action arrow A in FIG. 2a). This is followed by pivoting the draw bar/hitch bar 10 in the direction of action arrow B so that the second, opposite edge 50 formed at the point of connection between the second, bottom wall 14 and the first end 20 is inserted into the receiver box 34 (note FIG. 2b). This is then followed by the complete seating of the draw bar/hitch bar 10 in the receiver box 34 (note action arrow C in FIG. 2c) so that the apertures 24 in the side walls 16, 18 of the draw bar/hitch bar 10 are aligned with the apertures 52 in the opposing side walls of the receiver box 34.

This is followed by the pinning of the draw bar/hitch bar 10 into the receiver box 34 of the trailer hitch receiver assembly 36. Specifically, a hitch pin 26 of a type known in the art including a head or bent end 54 is inserted through the aligned apertures 24, 52. A pin clip 56 is then secured in a groove 58 on the opposite end of the hitch pin 26 in order to complete a secure connection (see FIG. 2d).

As should be appreciated from reviewing FIGS. 2a and 2b in particular, the insertion of the draw bar/hitch bar 10 into the trailer hitch receiver box 34 is performed in a simple and convenient manner. Only the projecting first edge 48 is initially inserted. This small edge 48 is easily brought into proper alignment with the receiver box 34 and, as should be appreciated, the draw bar/hitch bar is angled upwardly when this is done so that it may be easily manipulated without stooping or bending. Once that first edge 48 is inserted in the receiver box 34 a simple lowering, pivoting movement of the draw bar/hitch bar 10 functions to insert the second, opposite edge 50 thereof into the receiver box. More specifically, the angled end 20 (i.e. the inclined ends of the sidewalls 16, 18) of the draw bar/hitch bar engages the reinforced lip 38 at the bottom of the receiver box 34 and functions to efficiently and effectively guide the second edge 50 into place.

The foregoing description of a preferred embodiment of the present invention has been presented for purposes of illustration and description. It is not intended to be exhaustive or to limit the invention to the precise form disclosed. Obvious modifications or variations are possible in light of the above teachings.

For example, the projecting first edge 48 could be formed by the first end 20 and either the first side wall 16, second side wall 18 or bottom wall 14 instead of the top wall 12 if desired. In such an arrangement, the method of connecting the draw bar/hitch bar 10 into a receiver box 34 of a trailer hitch receiver assembly 36 would basically remain unchanged except that the direction of the pivoting action would change in order to correspond with the alternative structure.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and the variations are within the scope of the invention as determined by the appended claims when interpreted in accordance with the breadth to which they are fairly, legally and equitably entitled.

In the claims

1.) A draw bar/hitch bar, comprising:
a body including;
a.) a top wall;
b.) a bottom wall;
c.) a first side wall;
d.) a second side wall;
e.) a first end; and
f.) a second end
wherein said first end defines an included angle with said top wall of between substantially 65-85°.

2.) The draw bar/hitch bar of claim 1, wherein said top wall projects beyond said bottom wall at said first end between substantially 1.27-2.54 cm.

3.) The draw bar/hitch bar of claim 1, wherein said first side wall includes a first mounting aperture and said second side wall includes a second mounting aperture.

4.) The draw bar/hitch bar of claim 3, wherein said first and second mounting apertures are aligned.

5.) The draw bar/hitch bar of claim 1, wherein said included angle is about 72°.

6.) The draw bar/hitch bar of claim 5, wherein said top wall projects beyond said bottom wall at said first end about 1.68 cm.

7.) The draw bar/hitch bar of claim 6, wherein said first side wall includes a first mounting aperture and said second side wall includes a second mounting aperture.

8.) The draw bar/hitch bar of claim 7, wherein said first and second mounting apertures are aligned.

9.) A draw bar/hitch bar, comprising:
a body including;
a.) a top wall;
b.) a bottom wall;
c.) a first side wall;
d.) a second side wall;
e.) a first end; and
f.) a second end
wherein said top wall projects beyond said bottom wall at said first end between substantially 1.27-2.54 cm.

10.) The draw bar/hitch bar of claim 9, wherein said first side wall includes a first mounting aperture and said second side wall includes a second mounting aperture.

11.) The draw bar/hitch bar of claim 10, wherein said first and second mounting apertures are aligned.

12.) The draw bar/hitch bar of claim 9, wherein said top wall projects beyond said bottom wall at said first end about 1.68 cm.

13.) The draw bar/hitch bar of claim 12, wherein said first side wall includes a first mounting aperture and said second side wall includes a second mounting aperture.

14.) The draw bar/hitch bar of claim 13, wherein said first and second mounting apertures are aligned.

15.) A draw bar/hitch bar, comprising:
a body including;
a.) a first wall;
b.) a second wall;
c.) a third wall;
d.) a fourth wall;
e.) a first end; and
f.) a second end
wherein said first end defines an included angle with said first wall of between substantially 65-85°.

16.) The draw bar/hitch bar of claim 15, wherein said top wall projects beyond said bottom wall at said first end between substantially 1.27-2.54 cm.

17.) The draw bar/hitch bar of claim 15, wherein said included angle is about 72°.

18.) The draw bar/hitch bar of claim 17, wherein said top wall projects beyond said bottom wall at said first end about 1.68 cm.

19.) A draw bar/hitch bar, comprising:
a body including;
a.) a first wall;
b.) a second wall;
c.) a third wall;
d.) a fourth wall;
e.) a first end; and
f.) a second end
wherein said first wall projects beyond at least one of said second, third and fourth walls at said first end between substantially 1.27-2.54 cm.

20.) The draw bar/hitch bar of claim 19, wherein said first wall projects beyond at least one of said second, third and fourth walls at said first end about 1.68 cm.

21.) A method of inserting a draw bar/hitch bar into a receiver box of a trailer hitch receiver assembly, comprising:
inserting a first projecting edge of said draw bar/hitch bar into said receiver box;
pivoting said draw bar/hitch bar so as to insert a second, opposite edge of said draw bar/hitch bar into said receiver box; and
seating said draw bar/hitch bar fully into said receiver box.

22.) The method of claim 21, including pinning said draw bar/hitch bar into said receiver box.

23.) A draw bar/hitch bar, comprising:
a body including;
a.) a first wall;
b.) a second wall;
c.) a third wall;
d.) a fourth wall;
e.) a first end; and
f.) a second end
wherein said first wall projects beyond at least one of said second, third and fourth walls at said first end.
